(19) United States
(12) Patent Application Publication
(10) Pub. No.: US 2005/0145659 A1
(43) Pub. Date: Jul. 7, 2005

(54) Flip-up trunk space storage system

(75) Inventor: James A. Mulvihill, Royal Oak, MI (US)

Correspondence Address: LEAR CORPORATION, BLISS MCGLYNN, P.C., 2075 WEST BIG BEAVER ROAD, SUITE 600, TROY, MI, 48084, US

(73) Assignee: Lear Corporation

(21) Appl. No.: 10/750,801

(22) Filed: Jan. 2, 2004

(51) Int. Cl. B60R 7/00

(52) U.S. Cl. 224/282

(57) ABSTRACT

A trunk space storage system for motor vehicles comprising a hinge, a frame, and a storage pouch. This trunk space storage system allows users who cannot easily bend over to pick up or place objects into deep trunk spaces, such as the elderly or those with physical impairments, to have access of the objects placed into the trunk without having them roll back into the deep trunk space. This invention also provides for easy deployment and stowing with little strain on the body for those users who may suffer from physical limitations.

### FIELD OF INVENTION

This invention relates to the trunk space of a motor vehicle. More specifically, it relates to organization or storage of objects within that trunk space.

### BACKGROUND OF INVENTION

In motor vehicles, the trunk space is the place where drivers and their passengers store personal belongings so that the passenger area of the motor vehicle can be used more comfortably. As a result, there is a high demand for more trunk space in motor vehicles. Many manufacturers have met this demand by making trunk space deeper into the motor vehicle. Many drivers and their passengers have enjoyed this deeper trunk space with no problems. However, some drivers and/or passengers are either elderly or have certain physical disabilities that make it difficult for them to bend that far over to reach into the now deeper trunk space. Even if those users do not specifically place an object within the deep trunk space, there is still a chance that the object will roll back into that space during travel thereby making it extremely difficult for the user to retrieve the object from the back of the deep trunk space. As a result, there has been a demand to help solve this problem.

U.S. Pat. No. 5,685,470 (Moore) attempted to solve this problem with a removable storage apparatus. This apparatus attempted to keep objects held in trunk space from moving by using a removable netting that can be adjusted into varying positions. The problem invention is that people who are elderly or who suffer from certain physical difficulties would still have to bend into the trunk to secure items. This bending action can be very difficult for many people.

This invention solves the above-mentioned problems by utilizing a storage pouch that can be activated in one movement thereby securing objects placed in the trunk and preventing objects from rolling into the deep trunk space while not requiring users to maneuver into varying positions that may be difficult for them to obtain due to physical limitations.

### SUMMARY OF INVENTION

This invention relates to a trunk space storage system comprising a hinge, a frame, and a storage pouch. The frame further comprises a rigid material. The storage pouch further comprises a flexible material.

The frame rotates about the hinge to achieve a deployed or stowed position. The storage pouch is flexibly attached to the frame. The frame can be expandable to increase the size of frame and storage pouch. This gives a user the option of having a larger storage space. The frame does not have to be expanded if the user does not desire a larger storage space.

To achieve the deployed position, the frame with storage pouch rotates upward. As the frame rotates upward to its desired deployed position, the storage pouch opens and is ready for use. To achieve the stowed position, the frame and storage pouch rotates downward and folds neatly out of the way into the trunk opening wall.

### DETAILED DESCRIPTION OF THE DRAWINGS

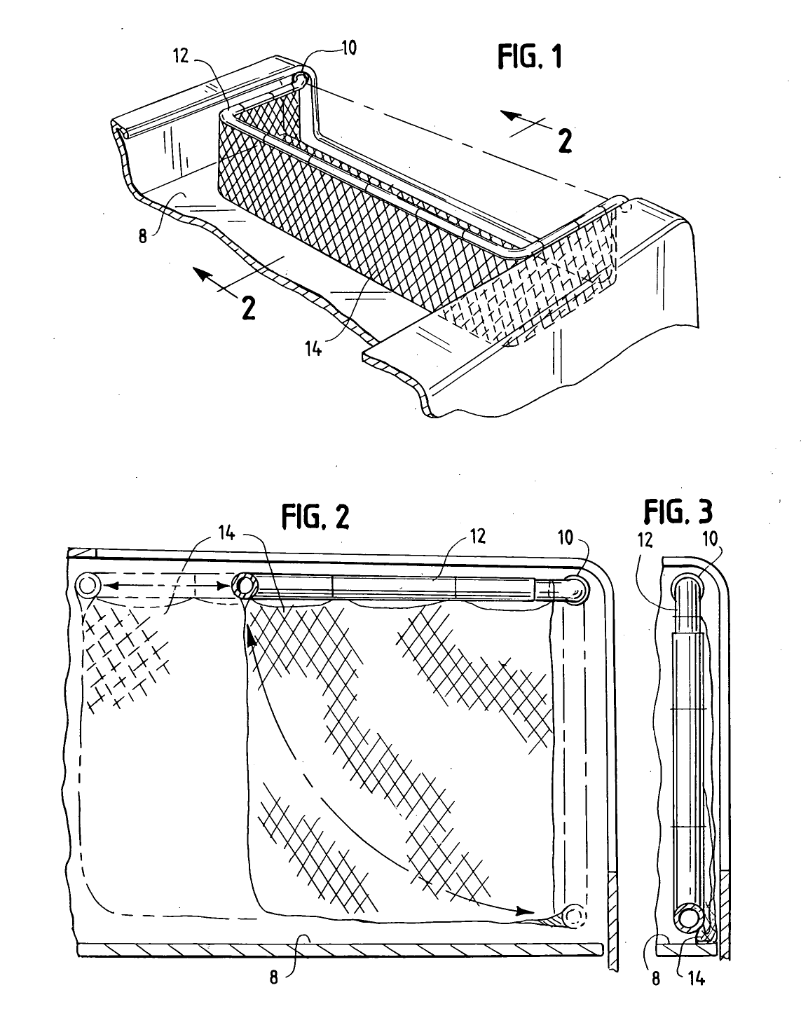

FIG. 1 depicts the trunk space storage system in its deployed position.

FIG. 2 is a cross-sectional view of the frame expanding.

FIG. 3 is a view of the trunk space storage system in its stowed position.

### DETAILED DESCRIPTION OF THE PREFERRED EMBODIMENT

In its preferred embodiment, this invention will be used in a motor vehicle, preferably one with a deep or big trunk space 8 near that trunk's opening 16. As seen in FIG. 1, this trunk space storage system comprises a hinge 10, a frame 12, and a storage pouch 14. The frame 12 further comprises a rigid material such as plastic or metal. The storage pouch 14 comprises a flexible material, such as fabric or netting. The storage pouch 14 is flexibly attached to the frame 12 and the frame 12 is rotatably associated with the hinge 10. The frame 12 can be expanded to increase the size of the storage pouch 14, as seen in FIG. 2. This allows a user to expand the size of the storage area if necessary. However, the frame 12 does not have to be expanded. The frame 12 can still be used in its smaller size.

This invention is to be installed near the front of the trunk space 8 near the trunk opening 16. There are two positions for this invention in its preferred embodiment, deployed or stowed. FIG. 1 shows the deployed position. FIG. 3 shows the stowed position.

To achieve the deployed position, a user must simply grasp the frame 12 and rotate the frame 12 upward about the hinge 10. The hinge 10 further comprises of any type of hinge assist, such as a mechanical, friction, hydraulic, or pneumatic hinge assist. The hinge assist helps to stabilize the frame and further support it in its deployed position. In its preferred embodiment, the hinge 10 must simply be able to rotate upwards to its fully deployed position and remain in place to support the frame 12, storage pouch 14, and any objects that may be placed inside the storage pouch 14. As the frame 12 lifts, the storage pouch 14 opens. In its deployed position, the storage pouch 14 is fully activated. A user may increase the size of the storage area by expanding the frame 12. Objects can be placed into the storage pouch 14 and will be held securely in place until the user needs to access them. The objects will not roll back out of the storage pouch 14 and into the deep trunk space 8. In its preferred embodiment, the frame 12 in its fully deployed position will utilize the full height of the trunk space 8. The exact height of the storage pouch 14 while deployed can vary depending on consumer needs.

When the user does not need to utilize this invention, it provides for easy stowing. The user must simply grasp the frame 12 and rotate in a downward fashion about the hinge 10. As the frame 12 rotates, the storage pouch 14 bends and folds neatly into the trunk opening wall 16. In its stowed position, the storage pouch 14 will be out of the way and will allow for full access of the trunk space 8.

Typically, users will want to utilize this invention its preferred embodiment while transporting numerous smaller objects, such as bags of groceries. For larger objects, a user will simply fold the invention into its stowed position.

The above presents a description of the best mode contemplated for carrying out this invention. The claims should not be read as limited to the described order or elements unless stated to that effect. Therefore, all embodiments that come with the scope and spirit of the following claims and equivalents thereto are claimed as the invention.

1. A trunk space storage system comprising:
at least one hinge adapted for attachment to a walls of the trunk space;
a frame operatively mounted to said hinge such that said frame can be rotated between a deployed position and a stowed position; and
a storage pouch supported by said frame.

2. The trunk space storage system as in claim 1, wherein said frame further comprises a rigid material.

3. The trunk space storage system as in claim 1, wherein said storage pouch further comprises a flexible material.

4. The trunk space storage system as in claim 1, wherein said frame is expandable to increase storage space of said storage pouch.

5. The trunk space storage system as in claim 1, wherein said storage pouch is flexibly attached to said frame.

6. The trunk space storage system as in claim 1, wherein said frame rotates upward about said hinge and said storage pouch opens as said frame moves away from the stowed position and toward the deployed position.

7. The trunk storage system as in claim 1, wherein said frame rotates downward about said hinge and said storage pouch bends and folds as said frame moves away from the deployed position and toward the stowed position.

8. A trunk storage system for a trunk comprising:
a frame with at least one end adapted for rotatable attachment to a wall of the trunk such that said frame can move between a stowed position and a deployed position;
a storage pouch supported by said frame such that said storage pouch opens as said frame moves away from the stowed position and toward the deployed position.

9. A trunk storage system as set forth in claim 8 further comprising at least one hinge operatively mounted to said end of said frame and adapted for rotatable attachment to the wall of the trunk such that said frame can move between a stowed position and a deployed position.

10. A trunk storage system as set forth in claim 8 wherein said frame is disposed substantially parallel and adjacent the wall when said frame is in the stowed position and wherein said frame is disposed substantially perpendicular from the wall when said frame is in the deployed position.
